(19) United States
(12) Patent Application Publication
(10) Pub. No.: US 2013/0226688 A1
(43) Pub. Date: Aug. 29, 2013

(54) CROWD FUNDING SYSTEM

(71) Applicants: Annie Harvilicz, Marina del Rey, CA (US); Andres Martinez, Los Angeles, CA (US)

(72) Inventors: Annie Harvilicz, Marina del Rey, CA (US); Andres Martinez, Los Angeles, CA (US)

(21) Appl. No.: 13/403,898

(22) Filed: Feb. 23, 2012

(51) Int. Cl. G06Q 10/06; G06Q 30/02

(52) U.S. Cl. 705/14.39; 705/27.1; 705/26.8

(57) ABSTRACT

A method and system to help fund projects, such as business ventures, charitable causes, and those generally in financial need, by providing a website where viewers can browse projects, select projects to fund, and donate money, or goods and services to fund the project. In the spirit of giving, the creator of a new project may also be required to make a donation or pledge to an existing project in order to have the new project published.

### FIELD OF THE INVENTION

The present invention relates to a system and method for funding projects.

### BACKGROUND OF THE INVENTION

Many people have great ideas but are without the resources to pursue those ideas. Others have great hearts, but lack funding to make life a better place. Still others simply do not have the resources to go about their daily business.

On the other side, there are many who are capable and willing to provide funding to those with great ideas, great hearts, or great debts, but simply do not know where to begin. Then there are those who are willing to give, but do not have the financial resources to give, although they may have something else of value.

There are websites that post information for business ventures and charitable causes that need funding. However, these are limited to simply donating money. In addition, the donor or pledger (i.e., the person donating or pledging money or other resources) does not get much recognition or promotion. Finally, there is the possibility that scammers may try to abuse the system. Therefore, there is still a need for a website that helps fund projects, such as business ventures, charitable causes, and those generally in need, where the donor or pledger can donate money, or goods or services, for the donor or pleasure and get some recognition, and where frauds and scams are reduced by forcing the project creator to also make a donation or pledge.

### SUMMARY OF THE INVENTION

The present invention is a system and method for providing a request engine in the form of a social network environment via the Internet to allow users to browse a catalog of projects generated by other users, where after contributing to fulfilling a request with a monetary gift to a requesting user, gifting users can create their own projects and publish them to the project catalog. These projects may be for any purpose but typical projects would revolve around worthy causes, such as business ventures, social needs, physical needs, financial needs, art projects and the like, where money is required to fulfill the project. In this way the requesting user must “give-to-get.”

This request engine is managed by a complicated shopping cart system with several unique attributes required to accommodate the “give-to-get” business method described above. Typical shopping cart systems facilitate the purchase of one or multiple items and accommodating coupons, but here, in addition to the typical shopping cart system, a number of technical and design challenges had to be overcome to accommodate for the conditional nature of the purchase, the transfer of funds from one user to many others.

Existing systems allow only for the transfer of funds from a single user to another user per transaction. The request engine can process multiple contributions at a time to many users. Complex interfaces are required to manage shopping cart functions like coupon-discounts in order to allow the user to properly define how, for example, “$5 dollars off” would be distributed amongst multiple recipients, as opposed to a traditional shopping cart where the entire “$5 dollars off” would be deducted from a total delivered to the merchant.

The shopping cart had to be integrated with an internal bank to manage the accounts of all the users in the system.

### BRIEF DESCRIPTION OF THE DRAWINGS

FIG. 1 illustrates a flow diagram of the system website;

FIG. 2 shows an embodiment of a homepage of the present invention;

FIG. 3 shows an embodiment of a browser page of the present invention;

FIG. 4 shows an embodiment of a project profile page of the present invention;

FIG. 5 shows an embodiment of a pledge page of the present invention;

FIG. 6 shows an embodiment of a webpage for pledging goods or services;

FIG. 7 is a flow diagram for creating a project;

FIG. 8A shows an embodiment of a create project page of the present invention;

FIG. 8B shows another embodiment of a create project page of the present invention;

FIG. 8C shows a transition from a create project page to a browseable directory;

FIG. 8D shows an embodiment of a checkout page of the present invention;

FIG. 8E shows an embodiment of an interface for redeeming coupons;

FIG. 9 shows an embodiment of a user profile page of the present invention;

FIG. 10 shows an embodiment of the badge board of the present invention; and

FIG. 11 shows an embodiment of the computer architecture that may be used in the present invention.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The crowd funding system 100 provides a social network website that allows users to create a new project, collect donations for the new project, browse for existing projects, and pledge to existing projects. An existing project is a relative term to refer to projects that already existed on the social network website at the time a user creates a new project.

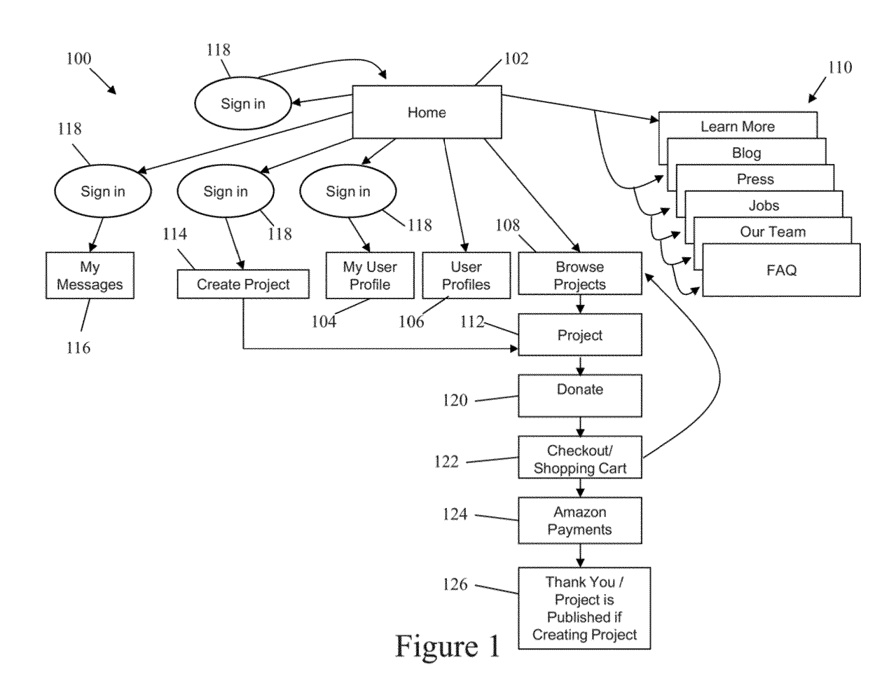

As shown in FIG. 1, the crowd funding system website 100 utilizes a variety of webpages to perform a variety of functions, including standard webpages from typical social network websites, such as a homepage 102, user profile pages 104, 106, browsing pages 108, and non-application pages 110 that provide information regarding the website. The crowd funding system 100, however, is distinguishable from other social network sites in that it also comprises a project page 112 and create project page 114 to allow users to set up projects for which the user would like to receive donations 120 in the form of pledges or actual donations to fund the project, commonly referred to a crowdfunding. Unlike other crowdfunding websites, however, the crowd funding system 100 utilities and intricate checkout or shopping cart 122 that allows pledgers to pledge or donate money, items, or services to fund a project. Donations are processed 124 by a third party. If creating a project 114, the project is published 126 after payment has been processed.

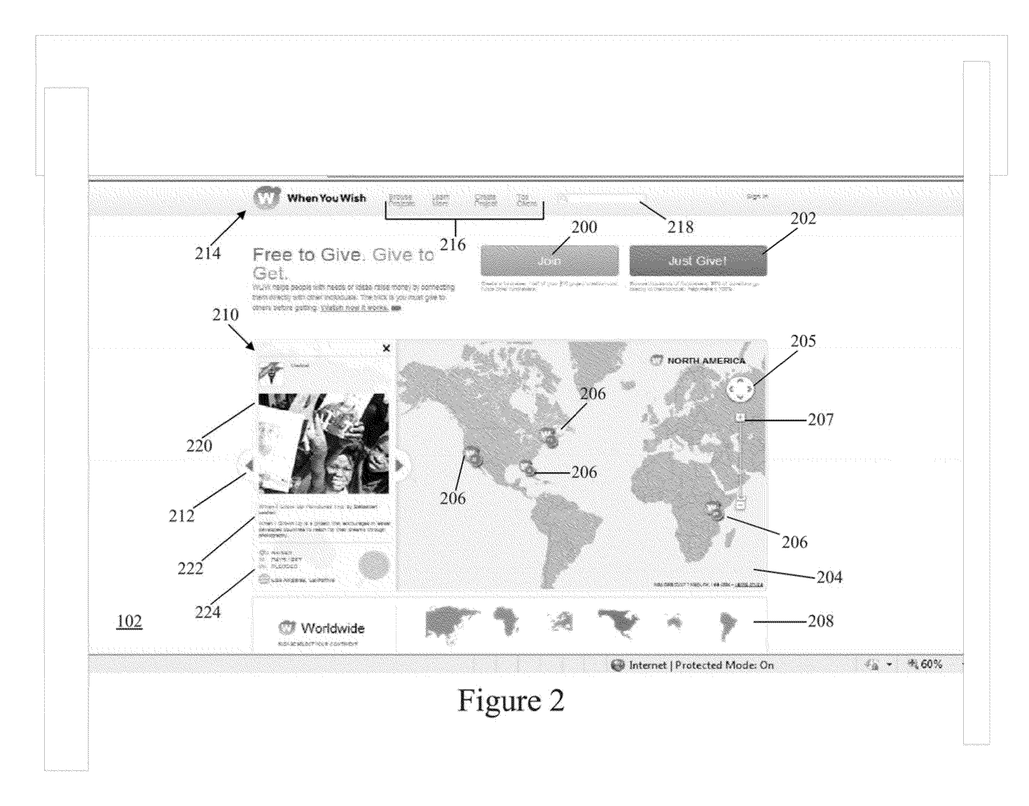

As shown in FIG. 2, the homepage 102 displays two call-to-action buttons, a registration button 200 (“Join”) and a donation button 202 (“Just Give”). Actuation of the registration button 200 directs the user to a typical sign-in page 118 where the user is allowed to join the social networking site by submitting the user's information. Actuation of the donation button 202 directs the user to the browse page 108 where the user is allowed to search for projects the user is interested in pledging to.

In the preferred embodiment, the homepage 102 also displays an interactive map 204 displaying markers 206 indicating locations where projects may be available to receive funding. The user can pan the interactive map 204 left, right, up, or down to find a general region, for example, by using a panning tool 205, scroll bars, or by actuating the map and dragging the map across the screen. In addition, the user can zoom in and out of the interactive map 204 to pinpoint a specific location, for example, by using a zoom tool 207 or by actuating the map by pinching, double tapping, double-clicking, and the like. In some embodiments, in a separate frame, the homepage 102 may further display a regional map 208 showing specific regions, such as specific continents. Actuation of a specific continent automatically zooms the user to that continent on the interactive map 204.

The marker 206 may be a project badge. The project badge may be a symbol indicating the type or category the project falls under. Hovering over or actuating a marker 206 displays a thumbnail image of project information 210 in a separate frame adjacent to the interactive map 204 in a pop-up window, in a new window, and the like. If multiple projects are located in this location, the marker 206 may indicate the number of projects in the area, and a scroll tool 212 may be provided to allow the user to scroll through the project information 210 of the available projects in the area selected. The project information 210 may contain, for example, a thumbnail picture 220 pre-selected by the project owner and a project description 222. The project description 222 may be a complete description, synopsis, brief summary, or abstract of the project to give the viewer an idea of the project. The project information 210 may also contain pledge information 224 regarding the project, such as the amount raised, the time left to make a pledge, number of pledgers, funding goal, and percentage of the goal pledged. The project information 210 may contain a link to a project profile page 400 with more detailed information regarding the project. For example, actuating the thumbnail image 220 may direct the user to the project profile page 400.

The homepage 102 may further comprise a navigation bar 214 with links 216 to various other pages on the website. The navigation bar 214 may be present on any and all webpages of the website so that the user can jump to any main page at any time. The homepage may also provide search tool 218.

From the homepage 102, the user can sign in 118 with the user's username and password if he has an existing account, or sign up (register) for an account if he has not already. Users may be able to sign up and log in using other existing accounts such as Facebook or a Google account. Registration includes providing information to create a user profile, which includes the user's contact information, identification, demographic, interests, location, and the like. This profile can be used to help the user find projects of interest. Signing in 118 will allow the user to access additional webpages on the website, such as the users own user profile page 104, the create project page 114, and a messaging page 116 where the user can send messages to other users on the website. In the preferred embodiment, whether a user is signed it or not, the user will be allowed to access user profile pages 106, and the browsing page 108 as well as any non-application page 110.

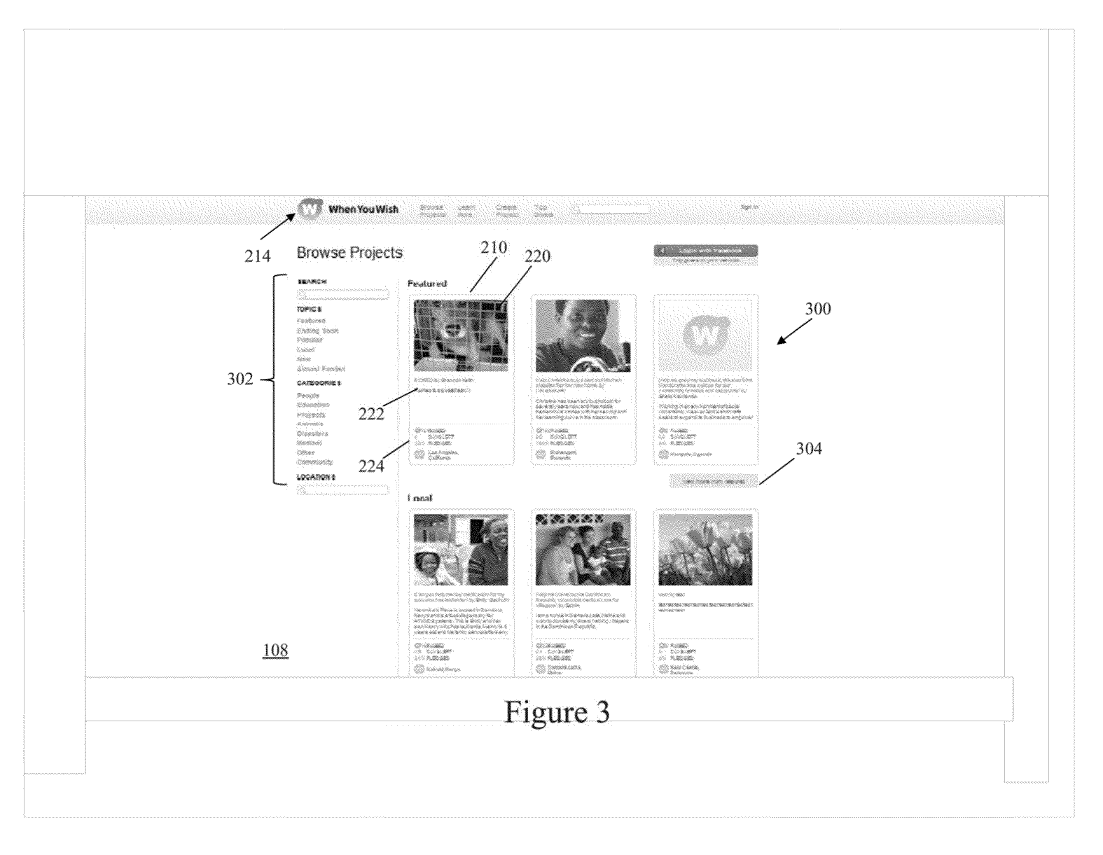

Once the user has logged in, the user can visit the browse page 108 (although the browse page 108 may be available for those who have not logged in as well). As shown in FIG. 3, in one frame, the browse page 108 displays a list of existing projects 300. In another frame, the browse page 108 displays a search or browse tool 302. The search/browse tool 302 allows users to search for projects based on keywords, location, and the like; or browse through predetermined topics and/or categories. Each topic or category may have sub-topics and sub-categories. Entering a keyword or selecting a topic or category displays existing projects 300 matching the filter requirements.

The existing projects 300 listed may be organized based on automatic filtering criteria and/or non-automatic filtering criteria. By way of example only, listed projects may include projects determined by the administrator as being particularly interesting (“Featured”), projects having deadlines for funding that are drawing near (“Ending Soon”), projects that are close to reaching their funding goal (“Almost Funded”), projects that are clicked on the most (“Popular Projects”) projects recently created (“New Projects”), and projects that are geographically near the user (“Local”). For automatic filtering criteria, the administrator may be able to deselect specific projects from appearing on the browse page 108.

The listed projects 300 may be displayed with the project information 210 showing a picture 220 representing the project funded, a project description 222, and pledge information 224. The administrator may determine how many projects under a single category will be displayed. If there are too many projects to display on a single page, then a “view more” link 304 can be provided to display more projects under a certain category or topic.

The display of the existing projects 300 may contain a link to a project profile page 400. The link may be embedded in the picture 220, the description 222 or as a separate link. Actuation of the link directs the user to the project profile page 400.

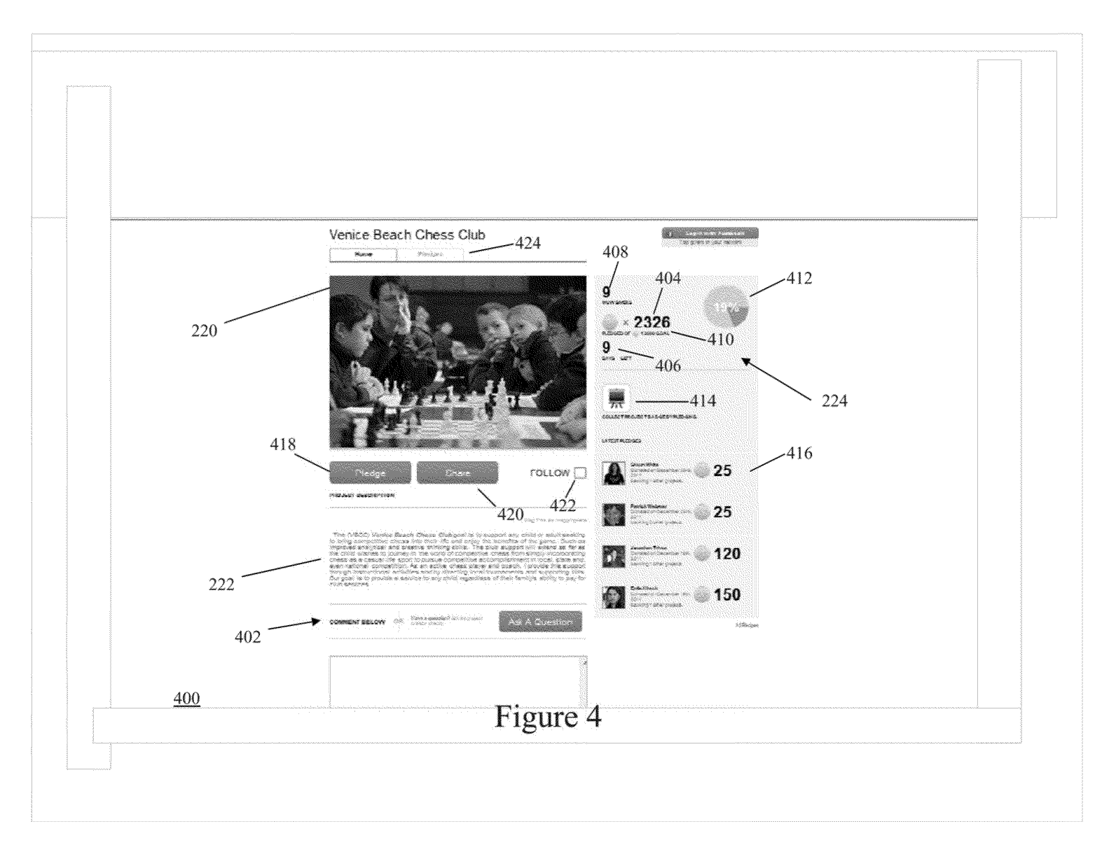

As shown in FIG. 4, the project profile page 400 may display a picture 220 representing the project, a video describing the project, a project description 222, and pledge information 224. These may be presented in separate frames. The project description 222 may contain user generated text and images describing the project.

The pledge information 224 displays information regarding the current pledge status of the project. For example, the pledge information 224 may display information regarding the amount raised up to date 404, the time left for funding the project 406, number of pledgers 408, the funding goal 410, percent of the goal currently funded 412, badges 414 associated with the project, discussed in more detail below, and pledger information 416, such as the pledger's name, amount pledged, other projects pledged to, the pledger's own projects, and the like. The pledger information 416 may also contain a link that takes the user to a pledger's page containing additional or more complete information about a specific pledger, such as the pledger's biography, the pledger's projects, projects pledged to by the pledger, and the pledger's badges.

A pledges tab 424 may also be provided so that the user can see a more complete list of pledgers to the current project. Actuating the pledges 424 tab displays a list of users who have pledged to the current project. The list may also contain brief or detailed pledge information of the pledger, such as the pledger's name, biography, thumbnail image, amount donated, badges accumulated by the pledger, projects the pledger has created or is managing, other projects the pledger has pledged to, a list of other users following this particular pledger, and the like. The pledge information may also contain a link, for example, through the name or thumbnail image that will display more detailed information about the pledger or any of the indicated information.

The project profile page 400 also displays a pledge tool 418 to allow the viewer to make a pledge to the project, and a share tool 420 to allow users to share the project information with others. A follow tool 422 may also be provided to allow the user to follow the project and receive automatic updates regarding the project. Other features on the project profile page include the ability to flag the project as inappropriate, create feeds, and the like.

The project profile page 400 displays a share button 420. Actuating the share button 420 may display html code that allows users to copy the code paste it on to the users own blog, website, or other account, such as Facebook, Twitter, Google, and the like to generate the project thumbnail image 210 or video for sharing on their blog or website to help spread the word about that particular project.

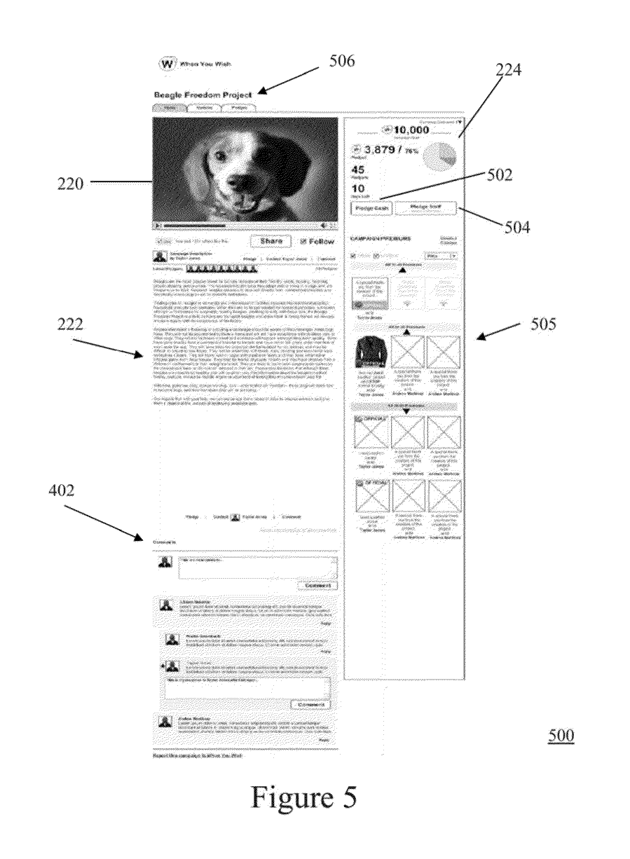

Actuating the pledge tool 418 displays a pledge page 500 as shown in FIG. 5. The pledge page 500 generally shows the same type of information as in the project profile page 400, such as a video or picture 220, a project description 222, pledge information 224, and a comments or questions section 402. Tabs 506 may be provided to allow the user to see updated information regarding the project or information regarding current pledges to the project.

The pledge page 500 also provides tools 502, 504 for the user to make a pledge. Unique from other crowdfunding websites is the ability for a user to either pledged cash 502 (“Pledge Cash” button), pledge goods or services 504 (“Pledge Stuff” button), or purchase goods or services from a listing of goods or services 505 (“Campaign Premiums”), where the proceeds from the sale are pledged to the project. Actuating the pledge cash tool 502 directs the user to a pledge cash page where the user can enter the amount of cash he wishes to pledge to the particular project. The pledge cash page may display the same type of information on the project profile page 400 so that the user is reminded of the particular project he is pledging cash to. In addition, the pledge cash page may also provide an option for the user to control the visibility of pledge information of the user that is displayed upon publication and recorded throughout the system. By way of example only, the pledger may only want his name and amount disclosed, his name only, the amount only without any name, no name or amount, the name of someone else for which the user made the pledge in honor of, and the like. This option may also be provided on a separate pledge confirmation page.

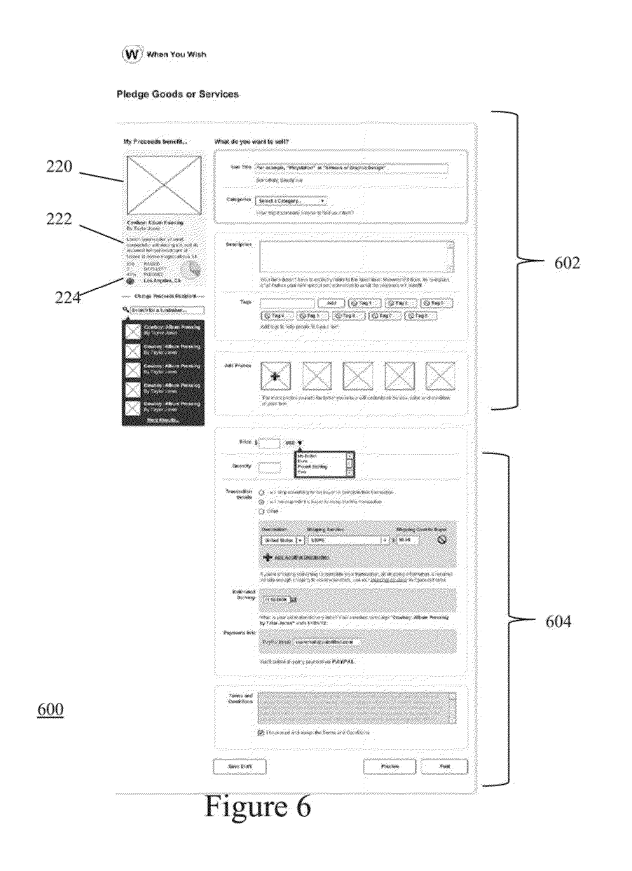

Actuating the pledge goods or services tool 504 directs the user to a pledge goods or services page 600, as shown in FIG. 6, where the user can input information regarding goods or services that he is willing to offer to a third-party. Proceeds from the payment by the third-party for the goods or services offered will be donated to the project specified by the pledger. This allows a pledger who may not have money to donate, but can offer something else of value, to pledge to a project.

The pledge goods or services page 600 displays the same type of information from the project profile page 400 so that the pledger is aware of which project he is pledging his goods or services to. The pledge goods or services page 600 also displays item description fields 602 for the user to input information regarding the good or service being offered for sale, such as a title, category, description, tags associated with the good or service, photos, and any other information that may facilitate a potential buyer to understand the good or service being offered. The pledge goods or services page 600 also displays transaction details fields 604 containing information regarding the financial transaction of the goods or services, such as pricing, quantity, shipping details, payment information, and the like. Once the information is complete, the user can save information of the draft, preview the information to see how it will look upon posting, or post the information. Once posted, the good or service offered for sale will be displayed in a listing of goods or services 505 on the project profile page 400 and/or or the pledge page 500 of that project. The pledge goods or services page 600 may also provide the option of controlling visibility of the pledge information. The system directs any proceeds from sale of the good or service to the project for which the offer for goods or services was made.

Finally, a pledge may be in the form of a purchasing a good or service, where the proceeds, all or some, are pledged to the project. A listing of goods or services 505 may be provided on the pledge page 500 for the user to browse or search for particular goods or services the user may be interested in purchasing. Actuation of a link associated with one of the good or service may take the user to a product page where additional details of the goods or services provided to help the user decide whether to purchase the goods or service.

A comments section 402 is displayed on the project profile page 400 to allow users to direct messages to the project's creator. Messages directed towards the project creator may be sent through a lightbox form. These messages go to the system's inbox and the user receiving the message will also get an email with the messages contents. The project profile page and any other page containing user generated information may also have a tab 506 or a link for updates for user generated updates regarding their projects. Updates may include additional photos, videos, and text with additional or updated information and responses to any questions or comments from others. A comment box may also be provided for others to leave a comment or as a question. A notification that a project has been updated may be sent via email to pledgers and/or others who have indicated an interest in the project.

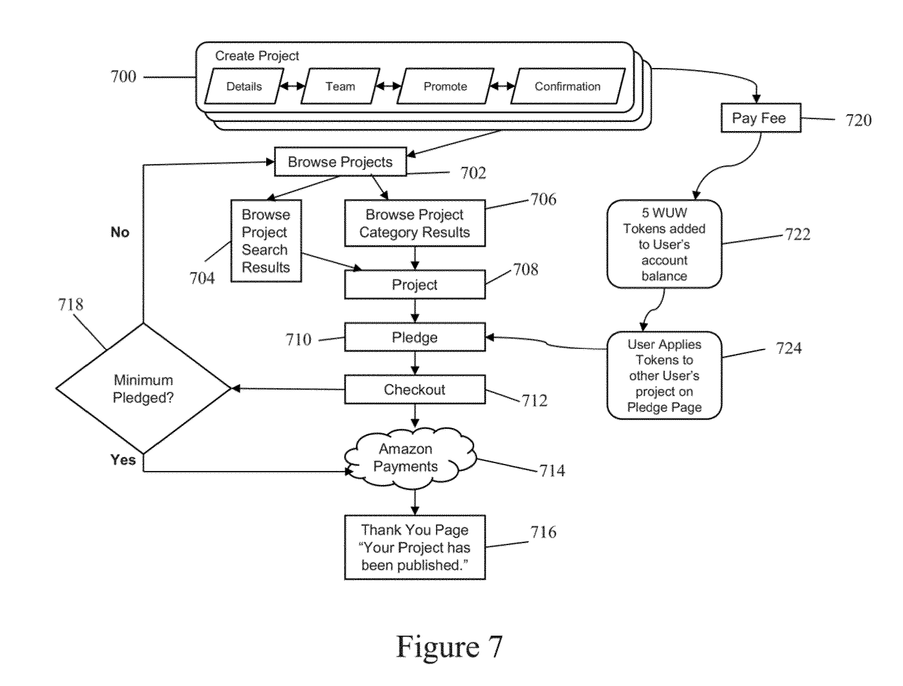

The creation and publication of a new project is unique, and at first blush, counterintuitive. A user creating a project will be referred to as the project creator. In general, as shown in the flow diagram in FIG. 7, after the project creator signs in, he can actuate a link in the navigation bar 216 to direct him to a create project page 800A where he can input information regarding this project 700. In order for the project creator to publish a project for which he would like to receive funding, the project creator must first make a pledge to an existing project. This may be referred to as a publication pledge to distinguish from a general pledge. Although used for the same purpose (i.e., directing to an existing project), the publication pledge may be subject to a predetermined minimum requirement in order to publish the new project. General pledges, however, may not be subject to a minimum (except the minimum token value), since the only benefit is to the recipient of the pledge. The project creator may browse existing projects 702. For example, the project creator may visit the browse page 108 and type in a keyword to browse through the browse project search results 704, or browse through the category results 706. Once the project creator has identified a project 708, the project creator makes a pledge 710 like making an online purchase (i.e., adding to a virtual shopping cart). The pledge can be in the form of money or tokens, a good or service offered for sale, or the purchase of a good or service advertised. The pledge is deposited into a virtual shopping cart and when project creator is finished he can check out 712. After checkout, the pledge is sent out to process the payment 714 and the project creator receives a confirmation page 716 with an indication that his project has been published. The system may be set up so that a predetermined minimum pledge must be made before publication of the project creator's project. Therefore, at checkout a determination is made whether the project creator met the minimum pledge amount 718. If the minimum pledge has not been made, then the project creator is taken back to the browse page 108 to browse for more projects 702. If the minimum amount has been pledged, then the project creator is taken to the payment processing step 714. In the preferred embodiment, payments are handled off-site by third party vendor, such as Amazon Payments. After payments have been made, the user is returned to the crowd funding system and his project is published.

The shopping cart uniquely handles three types of transactions. First, the shopping cart can receive listing fee from a user creating a project, a portion of which may be allocated to the token balance for pledging existing projects. Second, the shopping cart may be used to buy tokens to add to the token balance. Third, the shopping cart is used to receive pledges to projects. This can be done by registered or non-registered users. In summary, users can either place tokens or projects into their shopping cart. Pledged projects are only paid out if they reach their funding goal. If a project's funding goal is not met, the tokens are returned to the pledgers. If the pledge was in the form of purchasing a good or service, and the project's funding goal was not met, the proceeds may go to the donor of the good or service. When a project reaches its funding goal is a completed project.

Once all of the pledges have been made, the pledger can checkout. On the checkout page, the pledger's shopping cart is displayed showing the projects pledged to, the amounts of the pledges, totals, and available token balance. If the pledger pledges more tokens than he has available, the difference will be shown in a separate line to indicate the additional tokens that need to be purchased. If a project creator attempts to checkout before making the minimum required pledges, then a pop-up alert will inform the project creator that he has not satisfied the project publishing requirements and will give the option to return to checkout to increase any existing donations or browse for additional projects to donate to.

If all requirement have been made, the pledger is taken to a payment processor, such as Amazon Payments to enter payment information, such as credit card information. If the pledger was attempting to publish a project, then after payment is processed the project will be published.

If the pledger was simply making a pledge without creating a project and has not registered, then the pledger may be encourage to register. Once checkout has been complete, a thank you page may have a project thumbnail rotator suggesting additional projects to view after a purchase, such as a Coverflow style image rotator.

In some embodiments, in order to create a new project the user may be required to pay a project creation fee 720. A predetermined portion (for example, 50%) of the project creation fee may be converted to tokens and added to the project creator's token balance 722. Tokens are a form of money or currency having monetary value only the website. In some embodiments, rather than using tokens, actual money may be used. In order to publish a newly created project, the user may be required to allocate a predetermined minimum number of tokens to existing projects 724 as his pledge. Large donors, such as corporation, may be able to brand their own token graphics.

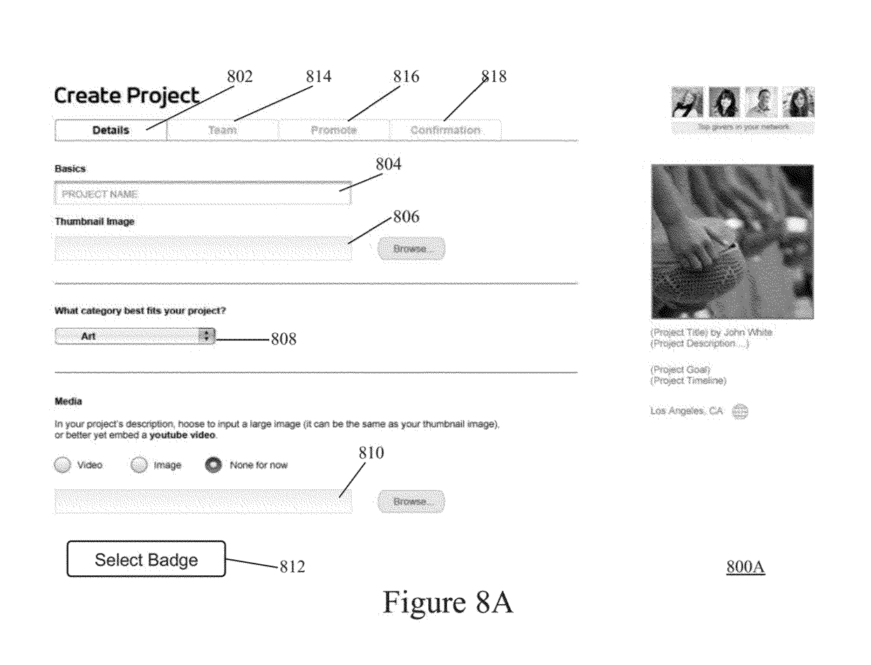

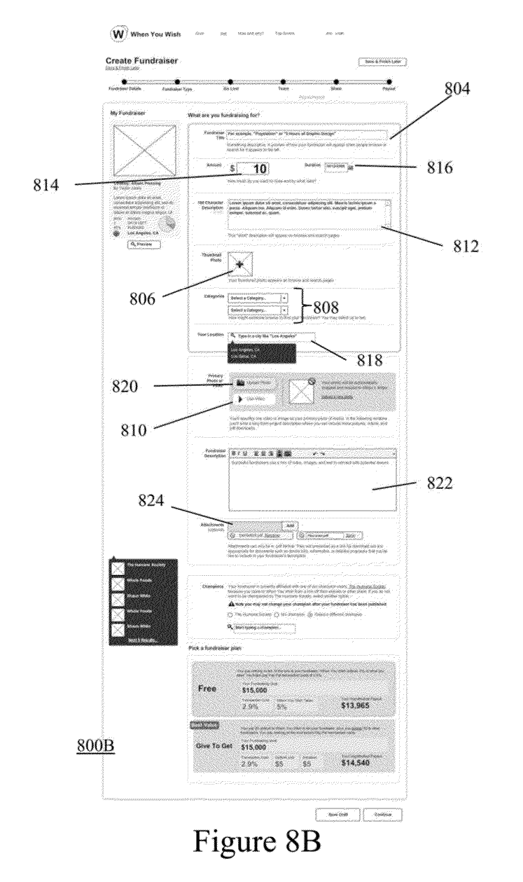

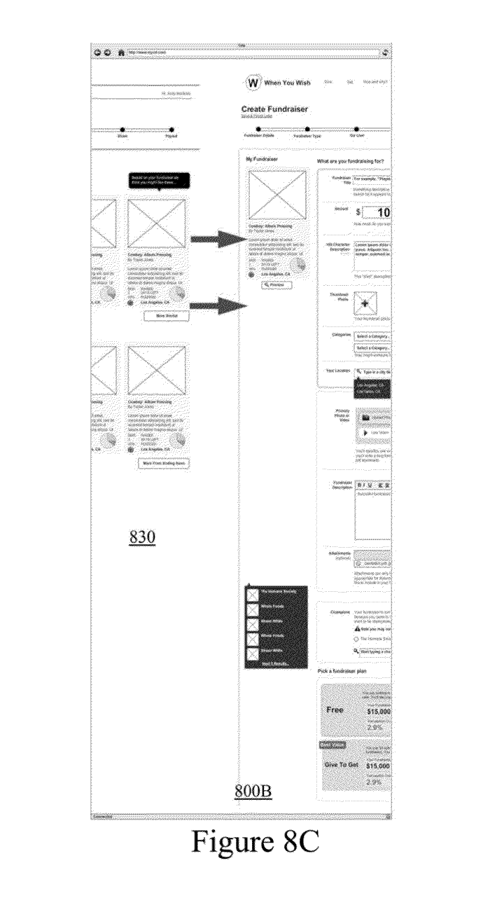

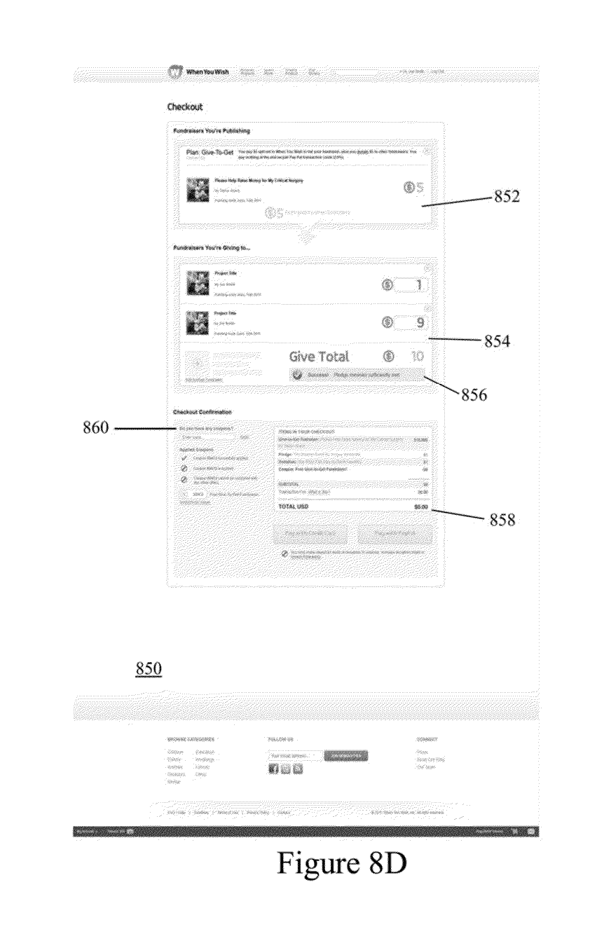

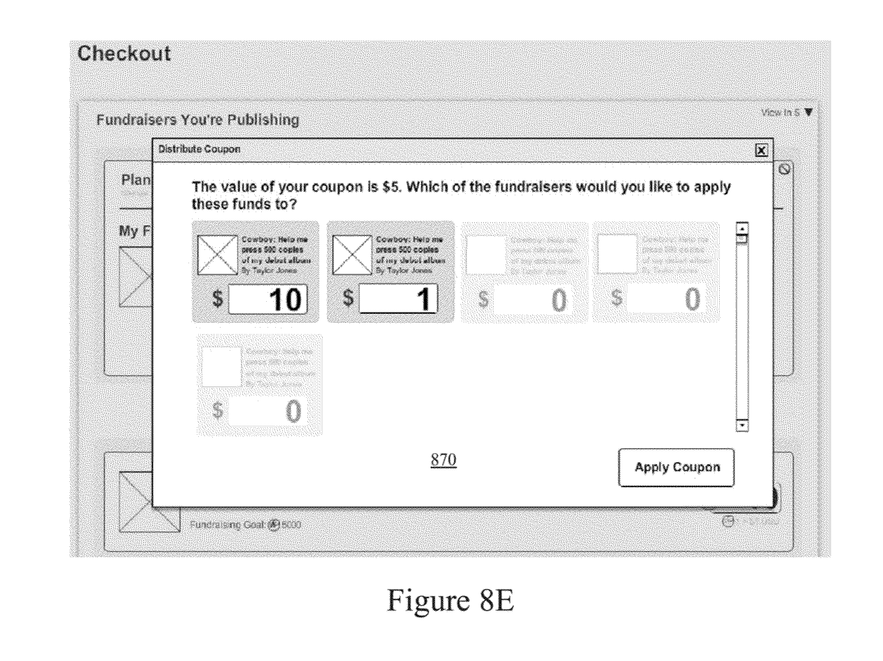

For those who have already registered and signed in, actuation of a create a project link will take the user to a create project page 800A as shown in FIGS. 8A and 8B. Those who have not registered or signed will be provided an option to log in or register. Once log in or registration is complete, the user is taken to the create project page 800A where the user can provide the necessary information to publish this project. In the preferred embodiment, the create project page 800A displays four tabs 802, 814, 816, 818 displaying various forms for which the user can fill out to create this project.

Under the project information tab 802 (“Details”), the project creator fills out a form, which may include providing all project information specified fields, such as a project name 804, a thumbnail image upload 806, a category 808, a video upload 810, a short description 812, a funding goal 814, a funding deadline 816, a location 818, a full photo upload 820, a detailed description 822, and attachment option 824, and the like. In the preferred embodiment, AJAX/Javascript is used to automatically update the information inputted by the user. In addition, form fields may be hidden or modified depending on the context and user actions. TinyMCE style rich area text inputs may be used so users can format material easily. Also, jQuery style date picker may be used to easily select deadlines for funding the project. An option for entering a coupon-code may also be provided for preferential pricing, for example, for users who use the system as their fundraising platform.

The user may select badges the user would like associated with the project. Badges are specific rewards pledgers receive when they donate to a project. In the preferred embodiment, the user selects one badge from a list provided by the administrator. Only a single badge will be displayed when the project is first published. The administrator may control which badges are subsequently displayed based on predetermined criteria. In addition, the administrator may suggest badges for the user based on various criteria, such as location and project category. In some embodiments, users may upload their own badges. In some embodiments, a project creator may create his own badge for his project. If there is no badge associated with a particular category, the user may get a location badge (a badge created by the administrator associated with the fundraisers location.

A badge selection link (not shown) may be provided on the create project page 800A. Actuation of the badge selection link may display a list of available badges in a lightbox format, in a new window, in a pop-up window, and the like. The badges may be displayed as an array. A category filter or a search field may be provided to facilitate the user in selecting a particular badge. Actuating a badge will constitute selecting of that badge.

Under a team selection tab 814 the project creator can identify additional team members that can serve as project managers for a project. Any project manager has the same privileges as other project manager. Examples of privileges of a project manager include inviting others to be project managers, editing the project settings, and promoting the project to their contacts. In the preferred embodiment, project managers may not delete the project, promote the project to another user's contacts, or get paid out. Only the project creator can be paid out if the project is successfully funded.

Under a promote tab 816, the project creator can compose email alerts to friends, family, and other contacts regarding their project and invite their contacts to pledge to the project. The project creator may be able to import contact lists from other accounts, such as Facebook, Gmail, Yahoo!, and the like.

The project creator may also have the option of keeping the project private. Private projects will not be published on the system's website. Rather, private projects may be accessed via a direct link sent to a recipient, although private pages may not necessarily be password protected or otherwise secure. In some embodiments, private pages may be password protected in addition to or in lieu of a link, a password may be delivered to the recipient.

Users may also be able to post their projects to other social networking websites. For example, a user may be able to post the project to a Facebook wall. In addition, users may be able to send a message to their pledgers with a click of a button. These messages will be sent via the system's communication vehicle rather than an outside email account.

Once the form is completed, a confirmation page 818 will display the pertinent information to allow the user to validate that the information before publication. At this point, the project remains in a “draft mode” and is not published until the user has made the proper payment in the form of a fee and/or pledge.

In the preferred embodiment, the user must pay a listing fee 720 combined with a mandatory pledge 710 to an existing project. The administrator establishes the minimum amount of the pledge. The user may be given the option to proceed to a browse page 108 to look for existing projects 300 the user may be interested in pledging to. In the preferred embodiment, a pop-up window, lightbox, new window, and the like may be displayed to explain the purpose of pledging first before receiving a pledge (the “give to get” principle). The browse page 108 may list projects that the user may be interested in based on the user's profile and/or the user's project.

In some embodiments, users may be provided two options for publishing a project: a free plan and a give-to-get plan. If they choose the free plan the shopping cart is bypassed and the project is immediately listed on the website. At the end of their fundraiser as set by the fundraiser deadline, the system will automatically deduct a predetermined percentage (e.g. 5%) from what was collected.

If users choose the give-to-get plan, they are taken to a step-by-step process that guides them through giving to an existing project 300 to satisfy a programmatically set conditional check within the shopping cart that determines if they have donated a certain amount of money to an existing project 300.

By way of example only, this process is enhanced and made possible through the following user interface features. Javascript powered effects keep the user on a single page or window. For instance, when a user selects the give-to-get plan, the create project page 800A “slides” away and in its place a browseable directory 830 of other user's fundraisers slides into place as shown in FIG. 8C. By keeping the user on a single page, the user interface has been designed to cue users that they are now in a step-by-step process that will guide users to satisfy the conditional checkout procedure necessitated by the business model of first giving to another project, in order to publish a user's own project.

Once a user donates the predetermined amount to an existing project or projects, the user is taken to a checkout page 850 as shown in FIG. 8D. The checkout page 850 displays information regarding the current project 852, and information 854 regarding the existing projects to which the user is giving. If the user changes donation values or otherwise proceeds to checkout before satisfying the conditional check of giving the required system set amount to checkout, the interface does not allow for the user to proceed by, for example, disabling buttons and displaying warnings. If the conditional check is satisfied, a message 856 is displayed indicating so, as well as a confirmation summary 858. An option for entering a coupon 860 may also be provided. Once all information is adequately provided the user may proceed to enter payment details.

Various design hurdles had to be thought out and overcome to achieve a shopping cart that could guide the user through the conditional nature of the give-to-get checkout procedure, such as programmatically setting the logic required to set the conditional check, providing enough interface elements such as sliding pages, tool tips, and contextual warning messages to keep the user moving forward through the payment procedure, adapting coupons to work in a system in which the value of the coupon's discount has to be individually applied to multiple items within the shopping cart instead of applying the value of the coupon to the total value of all items in the shopping cart.

The shopping cart of the present system is more complicated than a traditional shopping cart because most shopping cart systems collect items with a fixed price, then tabulate a total sale. This approach does not work on the present system.

The present system has three item types that can be added to a purchase: donations (user sets their own price), goods or services (user is given a fixed price), and listing fees to publish a fundraiser (user is given a fixed price). Furthermore, there are two user selectable donation types when a user gives to a fundraiser: donations and pledges.

For donations, a user gives another user a cash donation with no restriction. The donation is automatically held within the system's bank account until the funding period is over, at which time the funds raised are paid out to the project creator.

For pledges, a user gives another user a cash donation which is then held within a bank account for the duration of the project. At the end of the project, the funds are released to the project creator only if the project has reached the predetermined goal that had been set. If the goal is not reached the user who pledged to the project is refunded.

Therefore, the problem that arises is that the value of a coupon must be distributed by the pledging user amongst the pledged projects in his shopping cart in order to properly refund the pledging user in the event one or more of the fundraisers he is pledging to does not reach his project goal. For example, if there are two pledges in the shopping cart, one with a value of $8 and the other $12, and a coupon is applied with a value of $10, it means the total the user will pay out of pocket is $10. However, the value of the coupon cannot be subtracted from the total of the shopping cart because in the event one or both of his pledged projects does not reach its project goal, the exact amount of actual money the user had paid to each project must be known to refund as opposed to the coupon value which is not credited back as a refund. So, for example, if the $8 project reaches its funding goal but the $12 project fails to reach its goal, and a $10 coupon is applied, the issue becomes how much to refund the user, since he paid $10 dollars in pledges out of pocket.

To account for this, a graphical interface 870, as shown in FIG. 8E, was designed to allow the user to select the projects in his shopping cart to which the value of the coupon will be applied. In addition, the user may determine how much of he coupon can be applied to the different projects the user has selected. Associated logic can be programmed to itemize the deduction. If an existing project fails to reach its funding goal, the user's donated amount will be refunded back to the user. In some embodiments, the coupon value applied may be refunded as well.

Once the user has provided all the required information for a project, paid the appropriate fees, and made the appropriate pledges, his project will be published 716 and may show up on the browse page 108. A published project may be one that is complete with all the information the user wants to display, and has been published publicly or privately. As long as the project has not reached the end of its pre-set funding deadline, the project may continue to raise money. Pledging ends once the project has reached its funding deadline. Pledged projects are only paid out if they reach their funding goal. If a project's funding goal is not met, the tokens or money are returned to the pledgers.

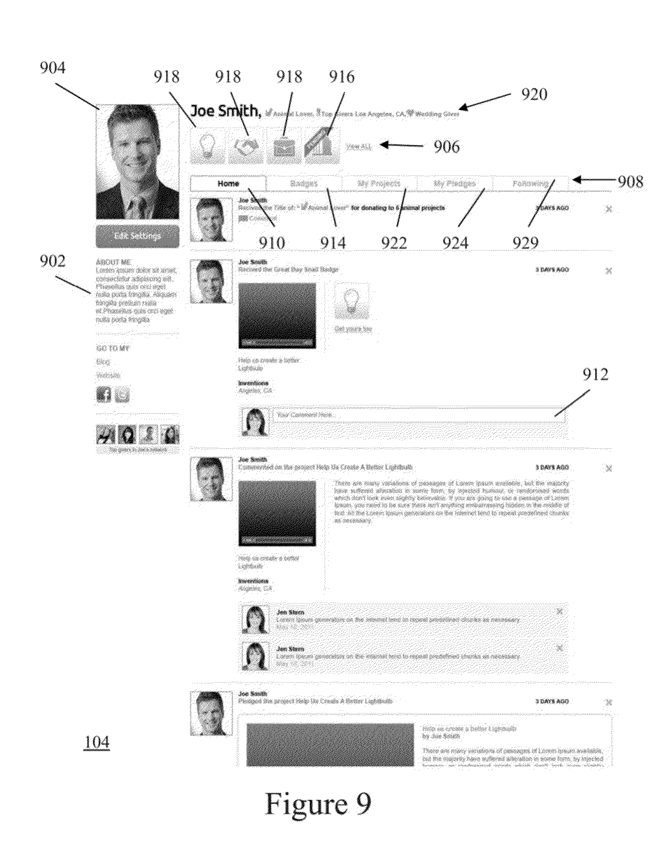

As shown in FIG. 9, the user profile page 104 allows users to input various information about themselves. The user profile page 104 may display the user's identification 902, an image 904, badges earned 906, and the various information displayed under different tabs 908. By way of example only, under a Home tab 910 news about the user's activity on the system may be displayed with the ability of other user's to comment 912 on the activity. News about the user's accolades, badges, updates on his projects, creation of new projects, comments made by the user, pledges made by user, interests of the user, and the like may be displayed.

Under a Badges tab 914, detailed information regarding the user's badges may be displayed. Badges are awarded every time a user donates to a project. However, badges remain “pending” until the project reaches its funding goal. A pending badge 916 may have a pending indicator associated with the badge. If a project fails to reach its funding goal, the user-pledger is notified and the “pending” badge is removed from the user's profile. If the project reaches its funding goal, the “pending” badge upgrades to a permanent badge 918 and the pending indicator is removed. Features may be built into the badge dynamics to increase the badges' worth and difficulty of attainment. When users create projects, they may select multiple badges to represent each project. Recognition titles 920 are awarded when a user gives to a predetermined number of projects from a specific location or category or accumulates a certain number of badges within a category.

Badges 918 and recognition titles 920 may be displayed in any fashion. In the preferred embodiment, titles are indicated next to the user's profile picture 904. Recognition titles 920 are awarded when a user hits a certain number of donations associated with a category, location, or other criteria. If a recognition title does not exist for a particular category or location, a new recognition title can be created.

Badges 918 may be displayed in a horizontal strip across the top of the page. In addition, badges may be displayed on the interactive map 204 to indicate the location of projects the user has donated to. Actuating the badge icon on the map displays the project thumbnail sidebar with a description of the project actuated. The sidebar can be cycled via left/right handles.

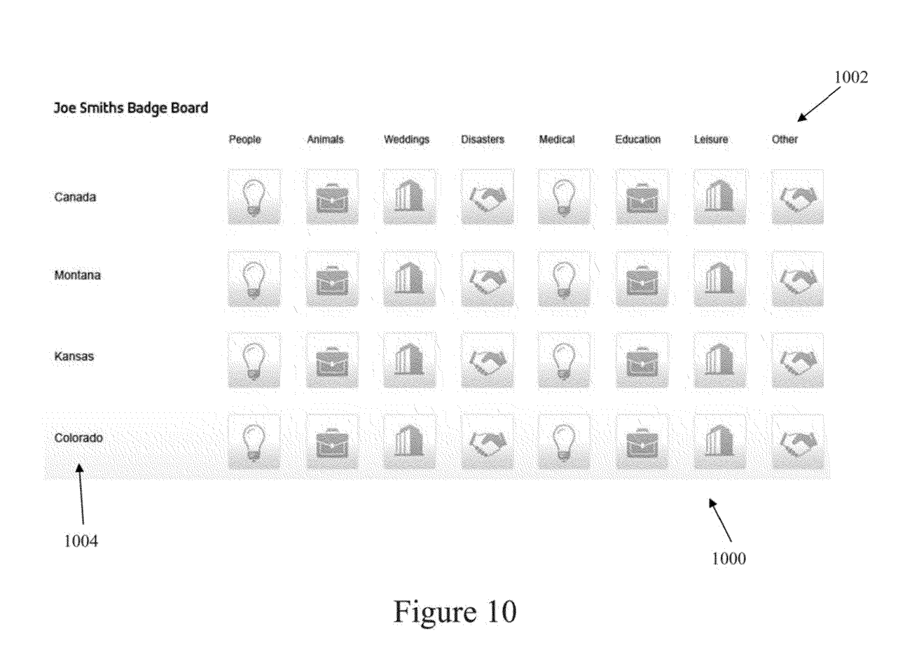

The badge tab 914 may also display the user's badge board 1000 as shown in FIG. 10. A badge board 1000 is a grid of a user's badges 918. In the preferred embodiment, the columns 1002 represent categories of projects and rows 1004 represent location of project. When the user creates his profile, the badge board 1000 displays an empty row for the location of the user. Each time the user makes a pledge for a project, the category for that project corresponding to the location of the project will be automatically populated with a badge. If the proper location row does not exist, a new row will be created. If the proper category does not exist, then a new category can be created.

A projects tab 922 and a pledges tab 924 displays information regarding the user's project and projects the user has pledged to, respectively. A follow tab 926 displays information regarding those following the user and/or projects the user is following.

A user profile settings page allows the user to edit, update, or modify the user's information. The user profile settings page may have a tab to edit the user's personal information (Profile tab), account information (Account tab), and view his transaction history (Transaction History tab). Under the Profile tab the user can also add, update, delete, or change his photograph or video. The user can also create a vanity url and add his own websites.

Under an account tab, the user can change contact information, such as emails, as well as password, connection vehicle (i.e., via Facebook, Gmail, etc.), and control email settings, among other settings.

Under a Transaction History tab, the user can view his pledge history, including the project name, the project status, the project end date, the amount of his pledge, and whether the pledge has been donated.

A message page may also be provided to allow users to send and receive messages to and from their pledgers and pledgees. The message page is similar to an email system with inboxes, sent boxes, and the like, and indicators of when messages have been sent, received, read, unread, etc. Actuating a message displays the sender and recipients communications.

The system also provides a directory of all registered users, referred to as a leaderboard. A frame may display a running tally of the total dollars raised by the system, average user donations, the total number of people who have pledged, and the like. Another frame may display featured givers with exceptional donation qualities. Another frame may display a feed of all users/projects with various sorting filters, such as your social network, people in your area, category, locations, gender, and the like.

The leaderboard may have tabs for additional sorting. For example, a tab for region and gender sorting may be provided. Another tab may be provided to view where currently logged-in users are located.

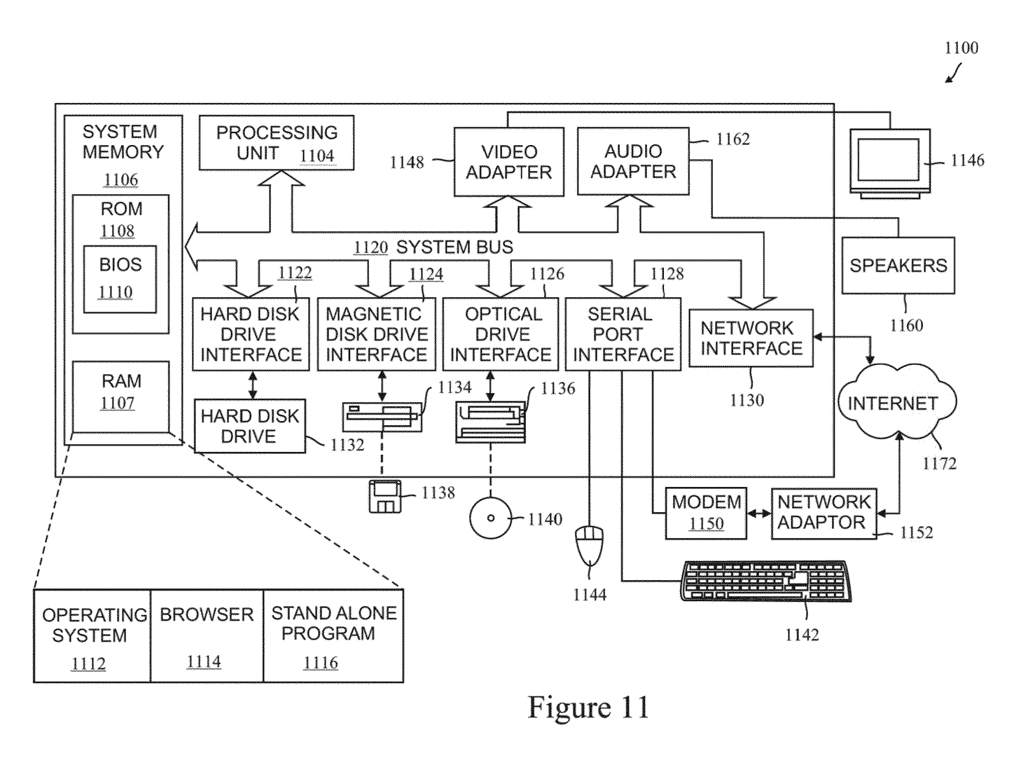

FIG. 11 depicts exemplary hardware for the crowd funding system in accordance with one aspect of the present application. The system or tool may be in the form of a computer 1100 that includes a processing unit 1104, a system memory 1106, and a system bus 1120 that operatively couples various system components, including the system memory 1106 to the processing unit 1104. There may be only one or there may be more than one processing unit 1104, such that the processor of computer 1104 comprises a single central processing unit (CPU), or a plurality of processing units, commonly referred to as a parallel processing environment. The computer 1100 may be a conventional computer, a distributed computer, a web server, a file server, or any other type of computer.

The system bus 1120 may be any of several types of bus structures including a memory bus or memory controller, a peripheral bus, a switched fabric, point-to-point connections, and a local bus using any of a variety of bus architectures. The system memory 1106 may also be referred to as simply the memory, and includes read only memory (ROM) 1108 and random access memory (RAM) 1107. A basic input/output system (BIOS) 1110, containing the basic routines that help to transfer information between elements within the computer 1100, such as during start-up, is stored in ROM 1108. The computer 1100 may further include a hard disk drive 1132 for reading from and writing to a hard disk, not shown, a magnetic disk drive 1134 for reading from or writing to a removable magnetic disk 1138, and/or an optical disk drive 1136 for reading from or writing to a removable optical disk 1140 such as a CD ROM or other optical media.

The hard disk drive 1132, magnetic disk drive 1134, and optical disk drive 1136 are connected to the system bus 1120 by a hard disk drive interface 1122, a magnetic disk drive interface 1124, and an optical disk drive interface 1126, respectively. The drives and their associated computer-readable media provide nonvolatile storage of computer-readable instructions; data structures, e.g., a catalog and a context-based index; program modules, e.g., a web service and an indexing robot; and other data for the computer 1100. It should be appreciated by those skilled in the art that any type of computer-readable media that can store data that is accessible by a computer, for example, magnetic cassettes, flash memory cards, digital video disks, RAM, and ROM, may be used in the exemplary operating environment.

A number of program modules may be stored on the hard disk 1132, magnetic disk 1134, optical disk 1136, ROM 1108, or RAM 1107, including an operating system 1112, browser 1114, stand along program 1116, etc. A user may enter commands and information into the personal computer 1100 through input devices such as a keyboard 1142 and pointing device 1144, for example, a mouse. Other input devices (not shown) may include, for example, a microphone, a joystick, a game pad, a tablet, a touch screen device, a satellite dish, a scanner, a facsimile machine, video camera, and the like. These and other input devices are often connected to the processing unit 1104 through a serial port interface 1128 that is coupled to the system bus 1120, but may be connected by other interfaces, such as a parallel port, game port, a universal serial bus (USB), and the like.

A monitor 1146 or other type of display device may also be connected to the system bus 1120 via an interface, such as a video adapter 1148. In addition to the monitor 1146, computers typically include other peripheral output devices, such as a printer and speakers 1160. These and other output devices are often connected to the processing unit 1104 through the serial port interface 1128 that is coupled to the system bus 1120, but may be connected by other interfaces, such as a parallel port, game port, a universal serial bus (USB), and the like.

The computer 1100 may operate in a networked environment using logical connections to one or more remote computers. These logical connections may be achieved by a communication device coupled to or integral with the computer 1100. The application is not limited to a particular type of communications device. The remote computer may be another computer, a server, a router, a network personal computer, a client, a peer device, or other common network node, and typically includes many or all of the elements described above relative to the computer 1100, although only a memory storage device has been illustrated in FIG. 11. Computer 1100 can be logically connected to the internet 1172. The logical connection can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the computer 1100 may be connected to the local network through a network interface or adapter 1130, which is one type of communications device. When used in a WAN environment, the computer 1100 typically includes a modem 1150, a network adapter 1152, or any other type of communications device for establishing communications over the wide area network. The modem 1150, which may be internal or external, is connected to the system bus 1120 via the serial port interface 1128. In a networked environment, program modules depicted relative to the personal computer 1100, or portions thereof, may be stored in a remote memory storage device. It is appreciated that the network connections shown are exemplary and other means of and communications devices for establishing a communications link between the computers may be used.

The system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an apparatus or device that utilizes or implements electronic, magnetic, optical, electromagnetic, infrared signal or other propagation medium, or semiconductor system. Examples of a computer-readable medium comprise a semiconductor or solid-state memory, magnetic tape, a removable computer diskette 1138, a random access memory (RAM) 1107, a read-only memory (ROM) 1108, a rigid magnetic disk and an optical disk 1140. Current examples of optical disks comprise compact disk-read only memory (CD-ROM), compact disk-read/write (CD-R/W) and DVD.

Described above, aspects of the present application can utilize the World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The Internet can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize analog telephone lines, digital T-1 lines, T-3 lines, or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet.

A web server may also include facilities for storing and transmitting application programs for execution on a remote computer. Likewise, a web server may also include facilities for executing scripts and other application programs on the web server itself.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of funding projects via the Internet, comprising:
a. establishing a website to advertise the projects as being available for funding;
b. receiving a request to create a new project from a user;
c. creating the new project based on information inputted from the user;
d. requiring the user to make a contribution to an existing project to publish the new project, wherein the contribution is selected from the group consisting of a pledge or a donation;
e. receiving the contribution for the existing project from the user; and
f. publishing the new project on the website after the contribution has been processed.

2. The method of claim 1, further comprising determining whether the contribution meets a predetermined minimum.

3. The method of claim 1, further comprising providing a checkout page, wherein the user has the option of donating to any existing project, pledging to any existing projects, or paying a fee to create a project.

4. The method of claim 1, crediting the user a predetermined amount of tokens for creating the new project, wherein the tokens can be used to make a payment at checkout.

5. The method of claim 1, further comprising providing the option of offering the pledge in the form of money or an offer for sale to fund the existing project, wherein any proceeds from the offer for sale is donated to the existing project.

6. The method of claim 1, further comprising offering to redeem a coupon, wherein when the user makes contributions to multiple existing projects, the user is offered a selection of which of the multiple existing projects to apply the coupon.

7. The method of claim 1, further comprising awarding badges to the user for making the pledge to the existing project.

8. The method of claim 1, wherein the website comprises a browse page displaying an interactive map of showing icons to indicate locations of projects that are available for funding.

9. A method of funding projects in need of funding, comprising:
a. establishing a website to advertise the projects as being available for funding;
b. establishing a checkout system, comprising providing an option for
i. receiving payment to donate to an existing project,
ii. receiving a pledge from a pledger for the existing project, or
iii. receiving a payment to pay a fee.

10. The method of claim 9, wherein the fee is paid by a project creator to create a new project to be published on the website.

11. The method of claim 10, further comprising the step of requiring the project creator to make a publication pledge to an existing project prior to publishing the new project on the website.

12. The method of claim 11, wherein if the publication pledge does not meet a predetermined minimum, further providing the project creator the option to increase the pledge or make an additional pledge.

13. The method of claim 9, further comprising paying out a project creator of the existing project if a funding goal has been met, and returning the pledge to the pledger if the funding goal is not met by a predetermined deadline.

14. The method of claim 9, further comprising providing the option of receiving the pledge in the form of money or an offer for sale to fund the existing project, wherein any proceeds from the offer for sale is donated to the existing project.

15. A system for funding projects, comprising a server connected to a network, the server comprising:
a. at least one processor;
b. a database for storing project information; and
c. a memory operatively coupled to the processor, the memory storing program instructions that when executed by the processor, causes the processor to:
i. receive payment to make a donation to an existing project,
ii. receive a pledge from a pledger for the existing project, or
iii. receive a payment to pay a fee.

16. The system of claim 15, wherein the fee is paid by a project creator to create a new project to be published on the website.

17. The system of claim 16, wherein the system requires the project creator to make a publication pledge to an existing project prior to publishing the new project on the website.

18. The system of claim 17, wherein if the publication pledge does not meet a predetermined minimum, further providing the project creator the option to increase the pledge or make an additional pledge.

19. The system of claim 16, further comprising paying out a project creator of the existing project if a funding goal has been met, and returning the pledge to the pledger if the funding goal is not met by a predetermined deadline.

20. The system of claim 15, further comprising providing the option of receiving the pledge in the form of money or an offer for sale to fund the existing project, wherein any proceeds from the offer for sale is donated to the existing project.
